(19) United States
(12) Patent Application Publication
(10) Pub. No.: US 2021/0110384 A1
(43) Pub. Date: Apr. 15, 2021

(54) Ad Hoc Neural Network for Proof of Wallet

(71) Applicant: Vikatron, Inc., Belmont, CA (US)

(72) Inventors: Thomas P. Vikstrom, Belmont, CA (US); Jason E. Belich, San Francisco, CA (US)

(21) Appl. No.: 17/050,821

(22) PCT Filed: Jul. 2, 2020
(86) PCT No.: PCT/US20/40782

§ 371 Date: Oct. 26, 2020

Related U.S. Application Data
(60) Provisional application No. 62/870,702, filed on Jul. 4, 2019.

(51) Int. Cl. G06Q 20/36; G06N 3/04; G06Q 20/40; G06Q 40/04; H04L 9/00

(52) U.S. Cl. CPC G06Q 20/3676; G06N 3/04; G06Q 20/4037; G06Q 20/389; G06Q 20/401; H04L 9/008; G06Q 2220/00; G06Q 40/04

(57) ABSTRACT

A proof of wallet approach is used for transaction validation for a digital currency. When a transaction is requested, a set of witness nodes are selected to form an ad hoc neural network. The witness nodes may be client devices of other users of the digital currency. Each witness node receives input information about the transaction (e.g., an encrypted amount and nonce) and neural network parameters (e.g., input weights and a bias). The input information passes through the ad hoc neural network, which generates an output validation value. The transaction is approved if the output validation value is consistent with a verification value generated from the transaction parameters, neural network parameters, and digital currency information stored on a blockchain. If the transaction is approved, the transaction is added to the blockchain in conjunction with the identity of the witness nodes and any other pertinent information

### CROSS-REFERENCE TO RELATED APPLICATIONS

This application claims the benefit of U.S. Provisional Patent Application No. 62/870,702, filed Jul. 4, 2019, which is incorporated by reference.

### BACKGROUND

### 1. Technical Field

The subject matter described relates generally to neural networks, and, in particular, to an ad hoc neural network configured to provide proof of balance for a digital wallet.

### 2. Background Information

Blockchain was developed as a means for parties to engage in financial transactions without the need for a single, trusted intermediary. Numerous cryptocurrencies exist that use a blockchain to record transfers of ownership of specific, identified digital tokens (or portions of digital tokens). In such systems, each transaction is recorded independently by several nodes. Typically, no one entity controls all of the nodes so it is exceedingly difficult for malicious actors to alter a transaction once it has been recorded by the nodes. Accordingly, the transactions can be conducted without the parties needing to trust each other, or any individual node provider.

However, existing approaches for recording transactions do not scale efficiently with transaction volume, significantly limiting the growth of cryptocurrencies. As more transactions take place, the blockchains used to record them get longer and more complex, requiring significant computing power to process and consuming unacceptable amounts of energy. For example, by the end of 2018, Bitcoin required a hash rate of approximately 50,000 tera hashes per second (TH/s).

Other problems with existing cryptocurrencies include slow transaction processing times and limited or no traceability of transactions. Generally, existing transaction processing times are too slow for real time transactions, meaning participants must wait before receiving confirmation that a transaction was successfully completed. With regard to the lack of traceability, while it may be attractive to some legitimate users, it is also attractive to those conducting illicit activities. For example, cryptocurrencies are a common form of payment for drugs and increasingly used by organized crime for money laundering. These problems only become worse as cryptocurrencies become more popular and the total number of transactions continues to grow.

### SUMMARY

The above and other problems may be addressed by a digital currency that uses a proof of wallet approach for transaction validation rather than analyzing the entire transaction histories of tokens. Proof of wallet may be provided by a governed, distributed, decentralized neural network. In various embodiments, when a transaction is requested, a set of witness nodes are selected to form an ad hoc network (e.g., an ad hoc neural network). The witness nodes may be client devices of other users of the digital currency. Each witness node receives input information about the transaction (e.g., an encrypted amount and nonce) and neural network parameters (e.g., input weights and a bias). The input information passes through the ad hoc neural network, which generates an output validation value. The transaction is approved if the output validation value is consistent with digital currency information stored on a blockchain (e.g., if the output validation value matches a validation value generated by a transaction server using the same neural network parameters). If the transaction is approved, the transaction is added to the blockchain in conjunction with the identity of the witness nodes and any other pertinent information (e.g., commissions and fees).

### BRIEF DESCRIPTION OF THE DRAWINGS

FIG. 1 is a block diagram of a networked computing environment suitable for providing proof of wallet with an ad hoc neural network, according to one embodiment.

FIG. 2 is a block diagram of one of the client devices of FIG. 1, according to one example embodiment.

FIG. 3 is a block diagram of the transaction server of FIG. 1, according to one example embodiment.

FIG. 4 illustrates an ad hoc neural network with one hidden layer, according to one embodiment.

FIG. 5 illustrates an ad hoc neural network with two hidden layers, according to one embodiment.

FIG. 6 is a flowchart illustrating a method for validating a transaction using an ad hoc neural network, according to one example embodiment.

FIG. 7 is a flowchart illustrating a method for a node in an ad hoc neural network to contribute to validation of a transaction, according to one embodiment.

FIG. 8 illustrates an example use of a proof of wallet validation system for a digital currency, according to one embodiment.

FIG. 9 a block diagram of an example computer system, according to one example embodiment.

Reference will now be made to several embodiments, examples of which are illustrated in the accompanying figures. It is noted that wherever practicable similar or like reference numbers are used in the figures to indicate similar or like functionality. Where similar elements are identified by a reference number followed by a letter, a reference to the number alone in the description that follows may refer to all such elements, any one such element, or any combination of such elements. The embodiments described are examples provided for illustration only. One skilled in the art will readily recognize that alternative embodiments of the structures and methods described may be employed without departing from the underlying principles.

### DETAILED DESCRIPTION

Users of a digital currency may be identified by a unique user identifier. The unique user identifier may be a public encryption key that can be used to verify that the user's transactions were signed using the user's private key. The public key may also be used to define the user's wallet address (e.g., by hashing the public key). A user's wallet maintains a current balance of the digital currency held by the user. The disclosure that follows describes approaches to verifying that a user has a sufficient balance in their wallet to complete a requested transaction (e.g., to transfer digital currency to another user) using an ad hoc neural network. Note that although the embodiments described use an ad hoc neural network, other forms of network may be used to validate transactions using the same or similar techniques.

### Example Systems

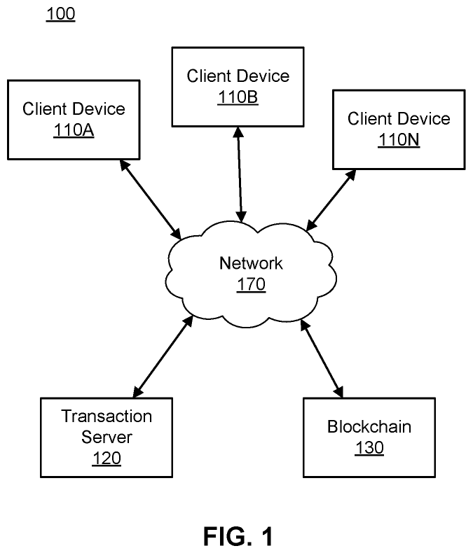

FIG. 1 illustrates one embodiment of a networked computing environment 100 suitable for providing proof of wallet with an ad hoc network. In the embodiment shown in FIG. 1, the networked computing environment 100 includes client devices 110, a transaction server 120, and a blockchain 130, all connected via a communication network 170. Although three client devices 110 are shown for illustrative purposes, the networked computing environment 100 may include many more (e.g., thousands or millions of) client devices. In other embodiments, the networked computing environment 100 may contain different and/or additional elements. In addition, the functions may be distributed among the elements in a different manner than described. For example, the transaction server 120 may be omitted entirely or the functionality attributed to the transaction server 120 and the blockchain 130 may be provided by a single entity. As another example, two or more transactions servers 120 may be used together and synchronized to crosscheck transactions, prevent double spending, or provide redundancy, etc.

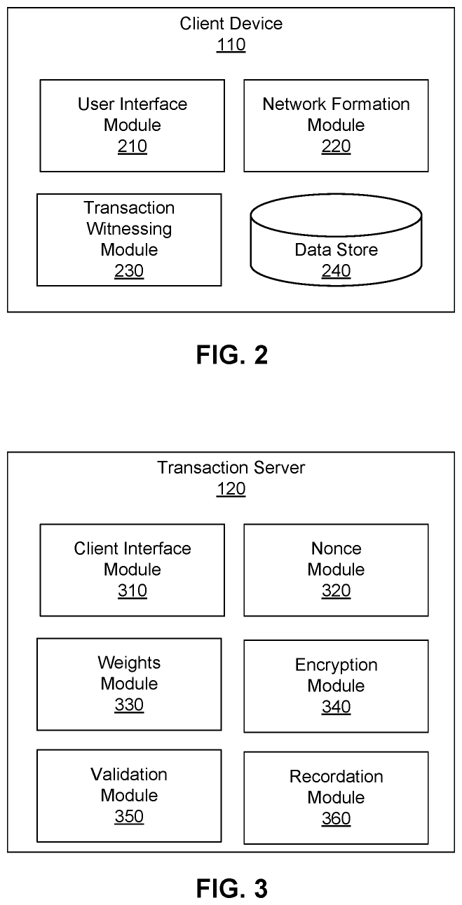

The client devices 110 are computing devices capable of receiving user input as well as transmitting and receiving data via the communication network 170. A client device 110 may be any suitable computer system, such as a desktop computer, personal digital assistant (PDA), laptop computer, mobile telephone, smartphone, set-top box, smart home device, or another suitable device. Software executing on a client device 110 (e.g., an application or app) may enable a user to request a transaction transferring value (e.g., a specified amount of digital currency) to another user. For example, the client device 110 may include a digital currency software (e.g., an app) for managing the user's digital wallet. The software may also configure the client device 110 to act as a witness node that contributes to the validation of transactions requested by other client devices as part of an ad hoc network. Various embodiments of client device 110 are described in greater detail below, with reference to FIG. 2.

The transaction server 120 facilitates the validation of transaction requests by ad hoc networks formed from sets of client devices 110. In one embodiment, the transaction server 120 provides transaction information and neural network parameters to the client devices 110 in an ad hoc neural network. The transaction information may include the amount of the transaction and a transaction nonce. The neural network parameters may include weights and one or more biases for the client devices 110 to use in processing the transaction request. In other embodiments, some or all of the parameters used by the client devices 110 in the ad hoc network are provided directly from other client devices “wallet-to-wallet.”For example, the current balances of the sender and receiver may be provided directly from their respective client devices 110, without going via the transaction server 110.

The transaction server 120 receives the output from the neural network and determines whether to validate or reject the transaction based on the received output. For example, the transaction server may separately calculate an expected output using the transaction information and neural network parameters and validate the transaction request if the output from the ad hoc neural network matches the expected output. Alternatively, the transaction server 120 may receive an indication of whether to validate the transaction from the neural network. A zero-knowledge proof may be used to determine whether the neural network output and the expected output match. Various embodiments of the transaction server are described in greater detail below, with reference to FIG. 3.

Alternatively, the transaction server 120 may be omitted with the corresponding functionality being distributed across multiple nodes in the network 170. In one embodiment, certain client devices 110 may be designated as “super nodes.” Super nodes are nodes corresponding to trusted users, such as those with a long transaction history, institutional users (e.g., banks or government entities), and the like. The neural network parameters may be encoded using Shamir secret sharing scheme, with each super node having one share of the neural network parameters. Thus, a given number of super nodes must collaborate to provide the neural network parameters to an ad hoc neural network. For example, if there are one hundred super nodes, the Shamir secret sharing scheme may be configured to require ten of the super nodes to contribute its share for the neural network parameters to be determined. In other embodiments, other techniques for sharing encoded neural network parameters may be used, such as double ratchet or Diffie-Hellman key exchange.

The blockchain 130 is configured to store information about validated transactions. For example, when the transaction server 120 validates a transaction, the transaction amount along with identifiers (e.g., public keys) associated with the sender, recipient, and each witness node may be added to the blockchain 130. Other information such as a commission earned by the witness nodes, fees charged to the sender or recipient, and the like may also be added to the blockchain 130. The blockchain 130 includes a timestamp indicating when the information about a transaction was added. Thus, given the difficulty in editing information once it has been committed to the blockchain 130, users may have confidence that a transaction appearing on the blockchain 130 was validated no later than the time indicated by the timestamp. The blockchain 130 can be a single blockchain used by the digital currency or a plasma blockchain that includes multiple smaller blockchains (e.g., one per user) that may ultimately be connected via shared transaction events (e.g., because the corresponding users engage in a common transaction as either a sender, receiver, or witness). The blockchain 130 may be governed or ungoverned and centralized or decentralized, depending on the specific configuration.

In various embodiments, a user's wallet is stored as a blockchain 130. The first time a user transacts using the digital currency (or registers to use the digital currency), a private/public key pair is created for the user. The first block in the user's wallet blockchain 130 may include information used to approve the identity of the person or entity, such as identifying paperwork, a third-party verification (e.g., by a verification service or government body), and additional information about the user (e.g., whether it is an individual or a business entity, a name, a location, etc.). The first block may also include an initial balance, which may include an amount provided in another currency, an initial balance awarded for registering, an amount of the digital currency sent to the new user by an existing user, or any combination thereof Δny transactions involving the user are written to the user's wallet blockchain, starting from the first block. Thus, all of the user's transactions ultimately connect back to the first block. Alternatively, the identity information for a user may be stored on a separate blockchain to the transactions, or not stored at all.

In some embodiments, third parties may add forks after any transaction in the blockchain to record additional information associated with the user. For example, approved or issued loans may be added to a user's blockchain providing additional information regarding the user's liquidity with regard to the digital currency beyond the current balance alone. As other examples, a wallet blockchain may also include forks linking to coupons, insurance cards, credit cards, stock, or anything else that the user may own and my wish to connect to their wallet.

Note that although much of the description herein focuses on digital currency, a similar approach may be applied to flat currency. In addition to or instead of a user's wallet having a digital currency balance, the wallet may include an indication of the user's flat currency balance. As with digital currency, an ad hoc network and blockchain may be used to witness, validate, and record that a flat currency transaction has occurred.

Although the term “blockchain” is used for convenience, one of skill in the art will recognize that other forms of ledger (including distributed ledgers) may be used without departing from the spirit or scope of what is disclosed. Accordingly, references to blockchains should be considered to encompass these other forms of ledger unless another meaning is apparent from the context.

FIG. 2 illustrates one embodiment of a client device 110 configured to enable a user to submit transaction requests and to act as a witness node in an ad hoc neural network. In the embodiment shown, the client device 110 includes a user interface module 210, a network formation module 220, a transaction witnessing module 230, and a data store 240. In other embodiments, the client device 110 may contain different and/or additional elements. In addition, the functions may be distributed among the elements in a different manner than described. For example, the network formation module 220 may be omitted and the witness nodes forming the ad hoc neural network may be selected by the transaction server 120.

The user interface module 210 provides a UI with which users can manage their digital wallets. In one embodiment, the user opens a wallet app on the client device 110 to view their current balance (or balances). The app provides controls to enable the user to request a transfer of a specified amount of a digital currency to another user. For example, the user may identify a recipient by providing the user's public key or by selecting another user from a contacts list and enter an amount to transfer to the recipient. The app may also enable users to issue invoices to other users and pay received invoices in a similar manner. Alternatively, the UI may be accessed via the network 170 (e.g., using a browser). In some embodiments, the user interface module 210 may provide a QR code generated from the user's public key. This QR code may be scanned by other users (e.g., merchants) or provided to over the network 170 (e.g., to an online merchant) to make payments.

The network formation module 220 selects other client devices 110 to act as witness nodes in an ad hoc network for validating a transaction requested by a user (e.g., via the UI provided by the user interface module 210). In one embodiment, the network formation module 220 broadcasts an invitation for client devices 110 to serve as witness nodes via the network 170. The transaction witnessing modules 230 of other client devices 110 receive the invitation and send a response accepting the invitation. Users may be provided with the option to opt-in or opt-out of their client device 110 serving as a witness node. Users may be incentivized to opt-in, such as by providing a commission in the digital currency being transferred to each witness node for the transaction.

The network formation module 220 receives the responses and selects a set of witness nodes. The set may have a predetermined size (e.g., three, five, seven, twelve, fourteen, or twenty witness nodes, etc.). In some embodiments, the set of witness nodes may be larger, including hundreds, or even thousands, of witness nodes. Any viable method may be used to select which responding client devices 110 to select as witness nodes. For example, the network formation module 220 may select the client devices 110 based on response time (e.g., those that responded fastest), network topology (e.g., those that are topologically closest to the user's client device in the network 170), or geographic proximity (e.g., those that are geographically closest to the user). In some embodiments, if insufficient suitable client devices 110 are available to serve as witness nodes, the transaction server 120 may act as one or more virtual witness nodes. A virtual witness node is a software entity that provides the functionality that would otherwise be provided by client devices 110 serving as witness nodes. Alternatively, some of the witness nodes for every transaction may be virtual nodes on the transaction server 120. The witness nodes will later be used to form an ad hoc neural network to validate the transaction request. The ad hoc neural network may include the client devices 110 of the sender and recipient as well as the witness nodes.

The transaction witnessing module 230 enables the client device 110 to serve as a witness node for transactions. When serving as a witness node, the client device 110 receives transaction information and neural network parameters (e.g., from the transaction server 120) and the transaction witnessing module 230 calculates one or more node outputs from the transaction information and neural network parameters. Example transaction parameters include the transaction amount, identifiers of the sender, receiver, and witnesses, and a nonce. Example neural network parameters include a weight for each transaction parameter and a bias.

In one embodiment, the transaction witnessing module 230 sums the sender's balance, receiver's balance, witness's balance, nonce, and amount transferred from the perspective of both sides of the transaction to generate two input values. The input values may be normalized using one or more logistic functions (e.g., a sigmoid function). The transaction witnessing module 230 provide the values to the ad hoc neural network to validate that they are equivalent, and this that the transaction is valid. The neural network calculates an output value by multiplying each input by the corresponding weight, summing the results, subtracting the bias, and applying an activation function (e.g., a sigmoid activation function). Some or all of the transaction parameters and neural network parameters may be encrypted (e.g., using homomorphic encryption). Various approaches to processing the output from each witness node to validate the transaction are described in greater detail below, with reference to FIGS. 3-5.

Once an ad hoc neural network has been formed, it may be used to perform additional functions beyond transaction validation. For example, the ad hoc neural network may be used to provide identity verification. In one embodiment, a user requesting a transaction provides their public key and is prompted to provide a photograph or series of photographs of themselves (e.g., captured using a camera of their client device 110). Where multiple photographs are provided (e.g., in the case of a video of the user's face), they may be used to build a 3D model of the user's face. The transaction server 110 may provide neural network parameters (e.g., weights and biases) such that the ad hoc neural network is configured to take the captured photo or photos as input and output a determination of whether the user associated with the public key requesting the transaction is depicted (e.g., based on a photograph or 3D model of the user's face provided when the user registered to use the digital currency). As another example, the ad hoc neural network may be used to identify patterns in available data (e.g., patterns in a user's transactions), which may be used to provide benefits such as improved customer service, targeted advertising, threat recognition, and the like.

The data store 240 includes one or more machine-readable media configured to store data used by the client device 110. The data stored may include software (e.g., a wallet app) as well as a history of transactions for which the client device 110 served as a witness node. The data store 240 may also include a local copy of the corresponding user's wallet balance, copies of transaction data and neural network parameters, or any other data used by the client device 110. Although the data store 240 is shown as a single entity, in some embodiments, the client device 110 may store data in multiple locations. For example, the client device 110 may access data remotely via the network 170 (e.g., by querying a distributed database or other cloud-based storage facility).

FIG. 3 illustrates one embodiment of a transaction server 120 configured to facilitate transaction validation by an ad hoc neural network. In the embodiment shown, the transaction server 120 includes a client interface module 310, a nonce module 320, a weights module 330, an encryption module 340, a validation module 350, and a recordation module 360. In other embodiments, the transaction server 120 may contain different and/or additional elements. In addition, the functions may be distributed among the elements in a different manner than described.

The client interface module 310 receives transaction requests from client devices 110. In one embodiment, a transaction request includes a sender ID, a recipient ID, and an amount to transfer. The transaction requests may also identify witness nodes to validate the transaction. Alternatively, the client interface module 310 may select witness nodes to validate a transaction request. The client interface module 310 may perform initial validation checks, such as checking that the sender and recipient IDs are valid, checking the amount to transfer is within a valid range (e.g., transactions above a certain value may be automatically rejected), and confirming an adequate number of valid witness nodes have been identified.

The nonce module 320 generates nonce values for transaction requests. A nonce value is an arbitrary number assigned to the transaction request. It may be selected randomly, pseudo randomly, or using some other function. Thus, even if all other aspects of transaction are identical, the nonce is almost certain to be different, distinguishing the transactions and making security breaches using techniques such as replay attacks virtually impossible.

The weights module 330 provides weights that should be used by each node in the ad hoc neural network. The weights module 330 may also provide one or more biases to apply to the output from nodes. In one embodiment, the weights (and biases where included) are selected such that, for any given set of inputs, the neural network will output approximately the total value (e.g., to within two decimal places) held in the wallets of each node in the ad hoc network (e.g., the sender's wallet, the recipient's wallet, and the wallet of each witness node). The weights module 330 may obtain the weights by training an arbitrary (e.g., a simulated) network of nodes to output using arbitrary (e.g., randomly generated) training. Because there are more input variables than output variables, there are an essentially infinite number of combinations of weights and biases that may be used (limited only by the quantization of the variables used). Thus, new weights may be generated periodically (e.g., daily, hourly, or even per transaction) by repeating the training process. The more frequently the weights are regenerated, the less likely it is that a malicious actor will determine the correct weights before the change. However, more frequent weight regeneration increases the computational resources required.

The encryption module 340 encrypts at least some of the parameters that will be provided to the nodes of the ad hoc neural network. In one embodiment, the encryption module 340 encrypts the nonce, weights, and biases. The encryption module 340 may also retrieve the wallet balances of the nodes in the ad hoc neural network, sum the balances, and encrypt the sum to generate a server validation value. Fully homomorphic encryption may be used. Thus, the nodes of the ad hoc neural network may perform operations using the encrypted nonce, weights, and biases as if they were unencrypted to generate an encrypted output that may be compared to the encrypted server validation value.

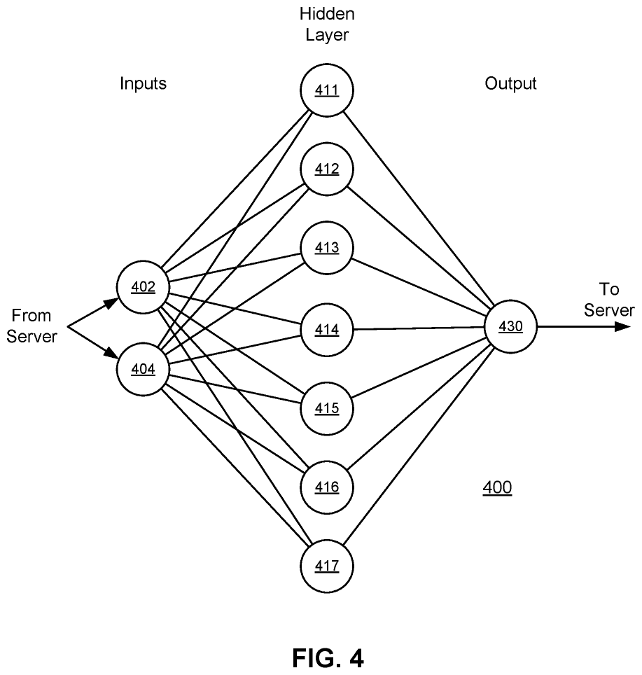

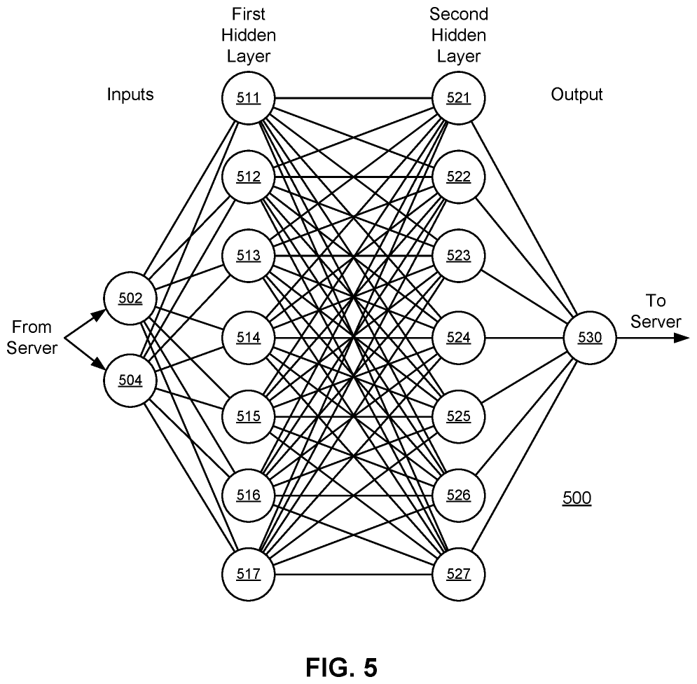

The validation module 350 provides the parameters to the ad hoc neural network that it uses to validate the transaction request. In one embodiment, the parameters include the encrypted nonce, node weights, and node biases. The ad hoc neural network nodes use the parameters to calculate output values as described previously with reference to FIG. 2. The output from the individual nodes is combined into a single neural network validation value. neural network validation value. For example, the node output values may be combined by multiplying each by a corresponding one of the weights and summing the weighted outputs. An output bias may also be subtracted from summed total. Assuming that the neural network was adequately trained and the transaction is valid (e.g., the sender's wallet has the balance the sender claims) then the neural network validation value should match the server validation value. Various approaches to combining the output of values are described in greater detail below, with reference to FIGS. 4 and 5.

The recordation module 360 records information about validated transactions to the blockchain 130. In one embodiment, the identity of the sender, recipient, and witness nodes (e.g., their public keys), as well as the amount of the transaction, are committed to the blockchain 130. Thus, if there is ever cause to investigate a particular transaction, the participants and witness nodes can be identified. Alternatively, an output node of the ad hoc neural network by submit the information about the transaction to the blockchain 130.

### Example Ad Hoc Neural Networks

The ad hoc networks used for transaction validation can have a wide range of structures and numbers of nodes. FIGS. 4 and 5 illustrate two example structures that may be used. Other embodiments may use different structures of neural network. In the embodiment shown in FIG. 4, the neural network 400 includes a pair of inputs 402, a single hidden layer with seven nodes 411-417, and a single output node 430. For example, the inputs may be a transaction value 402 and nonce 404 and the nodes 411-417 may correspond to the sender, the recipient, and five witnesses. The inputs 402, 404 are passed to each of the nodes 411-417, which apply the weights (and a bias if one is used) provided by the transaction server 120 and each send an output value to the output node 430. The output node 430 generates a weighted combination of the node outputs using weights (and a bias if one is used) provided by the transaction server 120. The weighted combination is the output from the neural network 400 that may be sent back to the transaction server 120.

The output node 430 can take various forms. In one embodiment, the output node 430 is an additional client device 110 selected by the network formation module 220 of the sender's client device or the transaction server 120. For example, formation of the neural network 400 may include identifying six other client devices 110 (in addition to those of the sender and recipient) and randomly designating five as witness nodes 413-417 and one as the output node 430. In this case, the output node 430 receives weights (and, optionally, a bias) to use from the transaction server 120 to combine the output values into a single neural network validation value. The output node 430 may send the neural network validation value to the transaction server 120 for comparison to the server validation value or the output node 430 may receive the server validation value from the transaction server and perform the comparison itself. In the latter case, the output node 430 may send a message to the transaction server 120 indicating the transaction request is validated (if the validation values match) or is denied (if the validation values do not match). A zero-knowledge proof may be used to confirm that the server and neural network validation values match. Zero knowledge proofs may also be used as a second layer of security for identity verification and confirming a wallet is legitimate without disclosing the wallet balance or the corresponding user's identity.

In another embodiment, the output node 430 is a super node. As described previously, a super node is a node corresponding to a trusted user. A super node may be selected as the output node 430 in a similar manner to which the witness nodes are selected (e.g., the sender's client device 110 may send out an invitation for a super node and select the first one that responds, etc.). The super node processes the outputs from the other nodes 411-417 in the same way as a regular output node 430. Similarly, the transaction server 120 may also serve as the output node 430.

In a further embodiment, the output node functionality is distributed across multiple nodes. The set of nodes making up the output node 430 may include some or all of the hidden layer nodes 411-417, one or more separate nodes selected during neural network formation, one or more virtual nodes provided by the transaction server 120, or any combination of the preceding nodes. Each node in the output node set receives the output from every hidden layer node 411-417 and combines the outputs using the parameters (e.g., weights and a bias) provided by the transaction server 120. The neural network validation value is then selected via consensus. For example, a Byzantine fault tolerance algorithm may be used in which two thirds of output node set must agree on a neural network validation value for that value to be used. If two thirds of the nodes do not agree on a value, the transaction may fail by default. Other thresholds for consensus may be used, such more than half or requiring complete agreement (i.e., all nodes have the same neural network validation value).

In the embodiment shown in FIG. 5, the neural network 500 includes two hidden layers. The first includes seven nodes 511-517 and receives two inputs 502, 504, much the same as the neural network 400 shown in FIG. 4. However, rather than the outputs from the nodes 511-517 being provided to an output node, each node in the first hidden layer provides its output to each node in the second hidden layer. In the embodiment shown, the second hidden layer also includes seven nodes 521-527. The nodes 521-527 in the second layer each generate a weighted combination of the outputs from the nodes 511-517 in the first layer using weights (and a bias if one is used) provided by the transaction server 120. The outputs from the nodes 521-527 in the second layer are provided to an output node 530, which generates a single output value for the neural network 500 in a similar manner to the output node 430 of the neural network 400 shown in FIG. 4.

### Example Methods

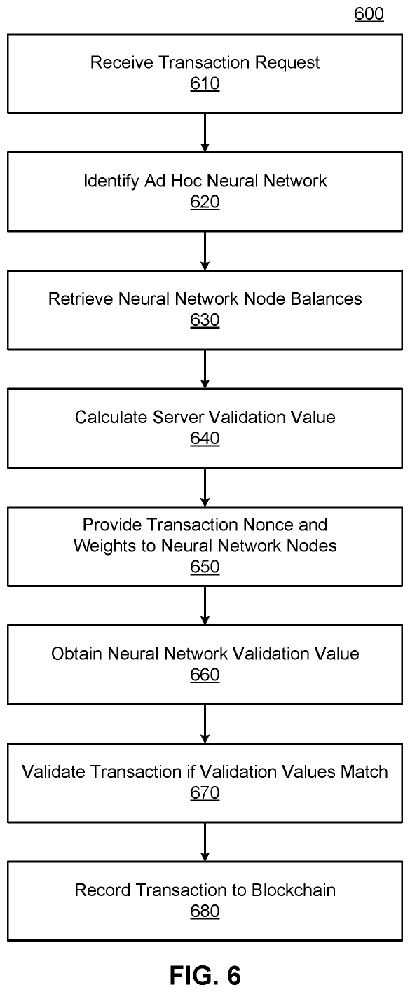

FIG. 6 illustrates an example method 600 for validating a transaction using an ad hoc neural network. For clarity and readability, the steps of the method 600 are described as being performed by the transaction server 120. However, some or all of the steps may be performed by other entities or components. For example, as described previously, a node of the ad hoc neural network (e.g., output node 430) may determine whether the neural network and server validation values match. In addition, some embodiments may perform the steps in parallel, perform the steps in different orders, or perform different steps.

In the embodiment shown in FIG. 6, the method 600 begins with the transaction server receiving 610 a transaction request. The transaction request may include a sender user ID, a recipient user ID, and a transaction amount. The transaction server 120 identifies 620 an ad hoc neural network to use for transaction validation. As described previously, ad hoc neural network can be made up from the client devices 110 of the sender and recipient as well as a set of witness nodes identified in the transaction request. Alternatively, the transaction server 120 may select the nodes of the ad hoc neural network.

The transaction server 120 retrieves 630 the wallet balances for the nodes in the ad hoc neural network and calculates 640 a server validation value. In one embodiment, the server validation value is calculated 640 by summing the wallet balances of the nodes and encrypting the result using fully homomorphic encryption. In other embodiments, other methods of calculating 640 a server validation value that can be compared to the output from the ad hoc neural network may be used.

The transaction server 120 provides 650 a transaction nonce and weights to the nodes of the ad hoc neural network. The transaction server 120 may also provide one or more bias values to the nodes of the ad hoc neural network. In one embodiment, the nonce, weights, and bias values are encrypted using homomorphic encryption. Thus, the nodes of the ad hoc neural network are not aware of the true value of the nonce, weights, and any bias used. The nodes of the neural network use the nonce, weights, and bias values as well as their own wallet balances to generate output values that are returned to the transaction server 120.

The transaction server 120 obtains 660 a neural network validation value. In one embodiment, the ad hoc neural network (e.g., the output node 430) calculates the neural network validation value from the outputs of the hidden layer nodes of the ad hoc neural network. For example, the output node 430 may calculate a weighted combination and the outputs from the hidden layer nodes and subtract a bias value. Alternatively, the neural network validation value may be calculated by the transaction server 120 via the network 170.

The transaction is validated 670 if the neural network validation value matches the server validation value. In one embodiment, the values must match to at least to decimal places for the transaction to be validated 670, but other thresholds may be used. Note that, as described previously, another entity may determine whether the neural network validation value matches the server validation value. In which case, the transaction server 120 may receive a message indicating whether the transaction is approved or denied that is signed by the entity or entities that compared the neural network and server validation values. Assuming the transaction is validated 670, the transaction is recorded 680 to the blockchain 130. For example, the user IDs of the sender, recipient, and witness nodes, along with the transaction amount, may be committed to the blockchain 130.

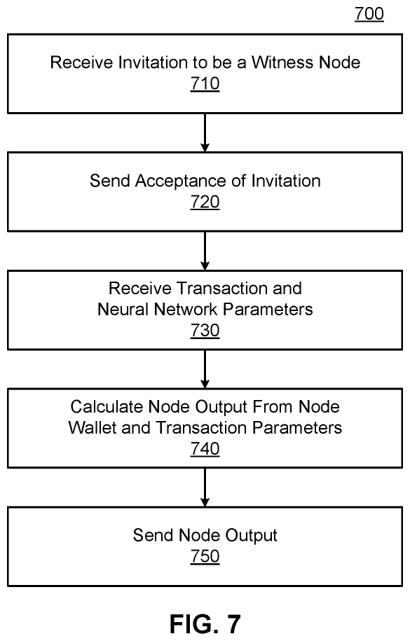

FIG. 7 illustrates an example method 700 for a node in the first (or only) hidden layer in an ad hoc neural network to contribute to validation of a transaction. For clarity and readability, the steps of the method 700 are described as being performed by a client device 110. However, some or all of the steps may be performed by other entities or components. In addition, some embodiments may perform the steps in parallel, perform the steps in different orders, or perform different steps.

In the embodiment shown in FIG. 7, the method 700 begins with a client device 110 receiving 710 an invitation to be a witness node for a transaction. Assuming the client device 110 is available as a witness node (e.g., if the corresponding user has opted-in to witnessing transactions), the client device 110 sends 720 an acceptance message in reply to the invitation.

The client device 110 receives 730 transaction and neural network parameters from the transaction server 120. As described previously, the transaction parameters may include the transaction amount and nonce while the neural network parameters may include weights for each input to the node. The neural network parameters may also include a bias value. The transaction and neural network parameters may be encrypted.

The client device 110 calculates 740 its output from its own wallet balance and the transaction parameters using the neural network parameters. In one embodiment, the client device 110 calculates 740 its output by multiplying the transaction nonce by a first weight to generate a weighted nonce, multiplying the transaction amount by a second weight to generate a weighted transaction amount, and multiplying the sender's balance, the receiver's balance, and its own balance by corresponding weights to generate weighted balances. The client device 110 sums the weighted nonce, weighted transaction amount, and weighted balances and subtracts the bias value. The result is provided as input to an activation function (e.g., a sigmoid activation function) to generate the node's output value. In other embodiments, the client device 110 may calculate 740 its output using different combinations of operations. For example, the bias or use of an activation function may be omitted.

Regardless of how the output value is calculated 740, the client device sends 750 the output value to one or more other nodes. In the case of the neural network with a single hidden layer (e.g., the neural network 400 shown in FIG. 4), the client device 110 sends 750 the output value to output node of the neural network. If the neural network has two or more hidden layers, the client device 110 sends 750 the output value to each node in the second hidden layer. Nodes in the second (and later) hidden layers operate substantially the same as nodes in the first hidden layer except that they use the outputs from the previous layer as input rather than the transaction parameters.

### Example Deployment

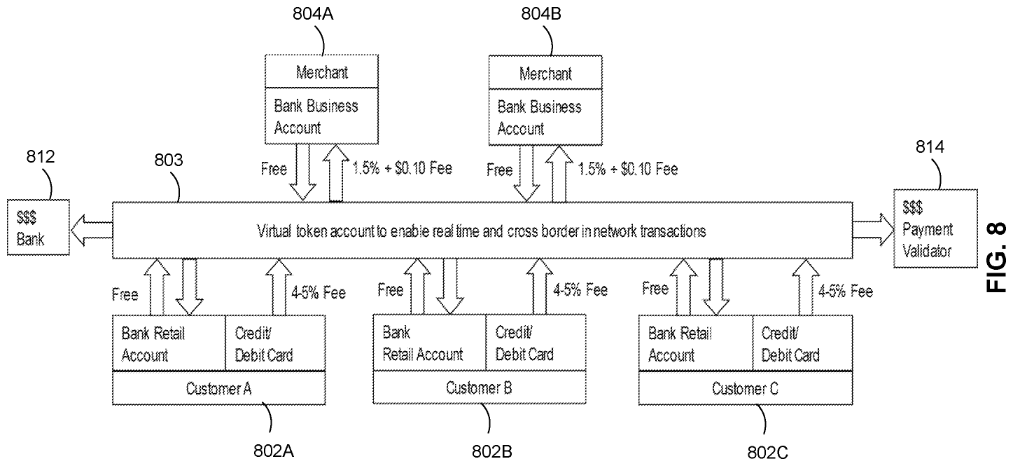

FIG. 8 illustrates an example deployment of a transaction validation system that uses an ad hoc network to provide a digital currency. In the embodiment shown, three customers 802 transact with two merchants 804. However, in practice, there may be many more customers and merchants using the digital currency. Digital currency transactions may be validated using an ad hoc network, as described previously, and processed using a virtual token account 803 to enable real time, cross border transactions.

Traditional transactions using a credit or debit card typically result in a 4-5% fee that is paid by the merchant 804 and generally passed on to the customers 802 in the form of increased prices. In contrast, transfers between accounts provided by a bank 812 that integrates the digital currency may be implemented with lower fees (e.g., a 1.5% charge plus a $0.10 fee). These fees may be split between the bank 812 and the payment validator 814. The fees provided to the payment validator may in turn be split by the coordinator (i.e., the entity providing the software for validating transactions) and the witness nodes used to validate the transaction as an incentive to users to allow their devices to serve as witness nodes. One of skill in the art will appreciate that a wide range of deployment configurations are possible and that FIG. 8 is just an illustrative example.

Computing System Architecture

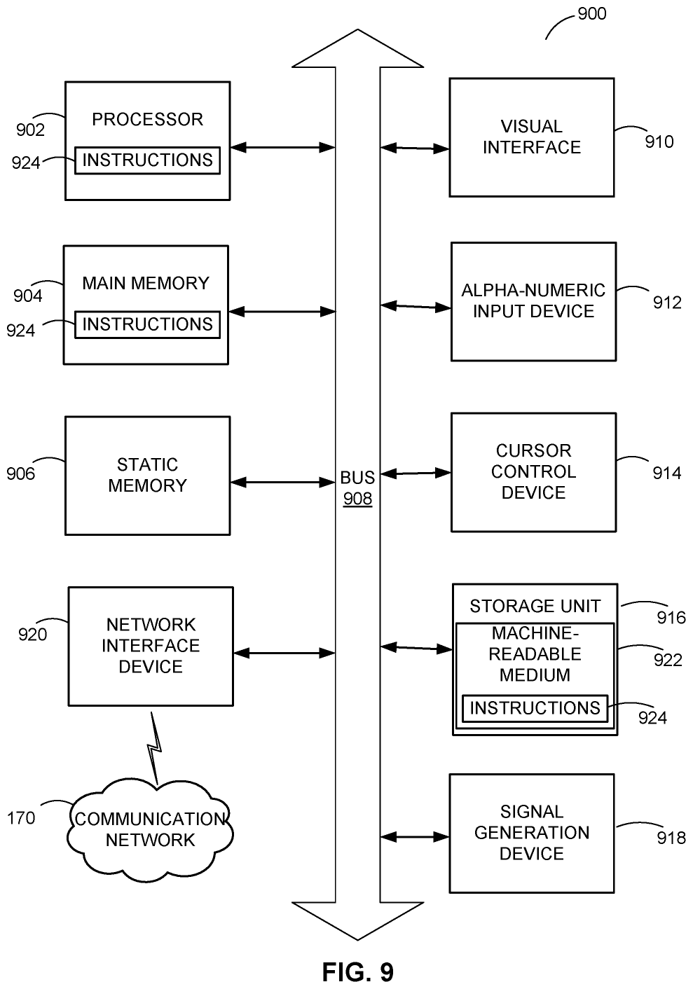

FIG. 9 is a block diagram illustrating components of an example computer system 800. The computer system 900 includes one or more processors 902 configured to execute program code. For convenience, the one or more processors 902 are referred to as “a processor” but it should be recognized that any function described as being performed by a processor may also be performed my multiple processors operating together. The program code may include instructions 924 that cause the processors 902 to perform operations such as those described previously with reference to FIGS. 1-8.

The computer system 900 may be a server computer, a client computer, a personal computer (PC), a tablet PC, a set-top box (STB), a personal digital assistant (PDA), a cellular telephone, a smartphone, a web appliance, a network router, switch or bridge, or any other machine capable of executing instructions 924 (sequential or otherwise) that specify actions to be taken by that machine. The computer system 900 may operate as a standalone device or may be connected (e.g., networked) to other machines. In a networked deployment, the computer system 800 may operate in the capacity of a server machine or a client machine in a server-client network environment, or as a peer machine in a peer-to-peer (or distributed) network environment. While only a single computer system 900 is illustrated, the term “computer system” shall be taken to include any collection of devices that individually or jointly execute instructions 924.

The example computer system 900 includes a processor 902 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 904, and a static memory 906, which are configured to communicate with each other via a bus 908. The computer system 900 may further include visual display interface 910. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 910 may include or may interface with a touch enabled screen. The computer system 900 may also include alphanumeric input device 912 (e.g., a keyboard or touch screen keyboard), a cursor control device 914 (e.g., a mouse, a trackball, a joystick, a motion sensor, or other pointing instrument), a storage unit 916, a signal generation device 918 (e.g., a speaker), and a network interface device 920, which also are configured to communicate via the bus 908.

The storage unit 916 includes a machine-readable medium 922 on which is stored instructions 924 (e.g., software). The instructions 924 may also reside, completely or partially, within the main memory 904 or within the processor 902 (e.g., within a cache) during execution by the computer system 900. In other words, the main memory 904 and the processor 902 are also machine-readable media. The instructions 924 may be transmitted or received over a communication network 170 via the network interface device 920.

While the machine-readable medium 922 is shown to be a single medium, the term “machine-readable medium” should be taken to include a single medium or multiple media (e.g., a centralized or distributed database, or associated caches and servers) able to store data (e.g., instructions 924). The term “machine-readable medium” shall also be taken to include any medium that is capable of storing instructions 924 for execution by the machine. The term “machine-readable medium” includes data repositories in the form of solid-state memories, optical media, and magnetic media.

### ADDITIONAL CONSIDERATIONS

Existing cryptocurrencies face problems with scalability. Processing transactions at the rate and volume demanded by users requires a huge amount of computing power and consumes large amounts of energy, which is both expensive and bad for the environment. In contrast, the disclosed approaches may be significantly less demanding in terms of computing power and energy requirements. For example, where existing approaches may require a server farm with tens or hundreds of Application-Specific Integrated Circuit (ASIC) servers to provide the proof of work and other proofs required for transaction validation, some embodiment of the disclosed approaches may be implemented with a single ASIC server operating as a transaction server 120 and the user's client devices 110 (e.g., smartphones) operating as the nodes in an ad hoc neural network.

Similarly, various embodiments of the disclosed approaches do not require a database to operate. Rather, the transaction server 120 may be connected to storage unit that stores the wallet blockchains and users' public keys. The public keys may be used as (or to derive) an address of the corresponding wallet blockchain (e.g., in a folder structure). Thus, any given wallet may be quickly located and accessed using the corresponding public key.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for using ad hoc neural networks to process transactions. Thus, while particular embodiments and applications have been illustrated and described, it is to be understood that the described subject matter is not limited to the precise construction and components disclosed. The scope of protection should be limited only by the following claims.

1-9. (canceled)

10. A non-transitory computer-readable medium storing instructions for contributing to validation of a transaction as part of an ad hoc network, the instructions, when executed by computing device, causing the computing device to perform operations including:
receiving an invitation to be a witness node;
sending an acceptance of the invitation;
receiving transaction parameters and network parameters;
calculating a node output using the transaction parameters and the network parameters; and
outputting the node output, wherein the witness node is part of a first hidden layer of an ad hoc neural network and the node output is sent to another computing device acting as a witness node in a second hidden layer of the ad hoc neural network.

11. The non-transitory computer-readable medium of claim 10, wherein the transaction parameters are based on a wallet balance of a sender and a wallet balance of a receiver.

12. The non-transitory computer-readable medium of claim 11, wherein the operations further include:
summing the wallet balance of the sender, the wallet balance of the receiver, a wallet balance of the computing device, a nonce, and an amount transferred from the perspective of the sender to generate a first input value;
summing the wallet balance of the sender, the wallet balance of the receiver, a wallet balance of the computing device, a nonce, and an amount transferred from the perspective of the receiver to generate a second input value; and
validating that the first and second input values are equivalent.

13. The non-transitory computer-readable medium of claim 12, wherein the operations further comprise normalizing the first and second input values using one or more logistic functions.

14. The non-transitory computer-readable medium of claim 10, wherein the transaction parameters are based on a transaction amount and a nonce.

15. The non-transitory computer-readable medium of claim 10, wherein the ad hoc network is an ad hoc neural network and the network parameters include a weight and a bias for the witness node.

16. The non-transitory computer-readable medium of claim 10, wherein at least some of the transaction parameters and neural network parameters are homomorphically encrypted.

17. (canceled)

18. The non-transitory computer-readable medium of claim 10, wherein the operations further include presenting an option for a user of the client device to opt-in to the client device witnessing transactions, wherein the acceptance of the invitation is sent responsive to having received user input indicating the user opts-in to the client device witnessing transactions.

19. (canceled)

20. (canceled)

21. A network node configured to contribute to validation of a transaction as part of an ad hoc network, the network node comprising:
a processor; and
a memory storing instructions that, when executed, cause the processor to perform operations including:
presenting an option for a user of the client device to opt-in to the client device witnessing transactions;
receiving an invitation to be a witness node;
sending an acceptance of the invitation, the acceptance being sent responsive to having received user input indicating the user opts-in to the client device witnessing transactions;
receiving transaction parameters and network parameters;
calculating a node output using the transaction parameters and the network parameters; and
outputting the node output.

22. The network node of claim 21, wherein the transaction parameters are based on a wallet balance of a sender and a wallet balance of a receiver.

23. The network node of claim 22, wherein the operations further include:
summing the wallet balance of the sender, the wallet balance of the receiver, a wallet balance of the computing device, a nonce, and an amount transferred from the perspective of the sender to generate a first input value;
summing the wallet balance of the sender, the wallet balance of the receiver, a wallet balance of the computing device, a nonce, and an amount transferred from the perspective of the receiver to generate a second input value; and
validating that the first and second input values are equivalent.

24. The network node of claim 23, wherein the operations further comprise normalizing the first and second input values using one or more logistic functions.

25. The network node of claim 21, wherein the transaction parameters are based on a transaction amount and a nonce.

26. The network node of claim 21, wherein the ad hoc network is an ad hoc neural network and the network parameters include a weight and a bias for the witness node.

27. The network node of claim 21, wherein at least some of the transaction parameters and neural network parameters are homomorphically encrypted.

28. The network node of claim 21, wherein the witness node is part of a first hidden layer of an ad hoc neural network and the node output is sent to another computing device acting as a witness node in a second hidden layer of the ad hoc neural network.

29. A method for contributing to validation of a transaction as part of an ad hoc network, the method comprising:
receiving an invitation to be a witness node;
sending an acceptance of the invitation;
receiving transaction parameters and network parameters, the transaction parameters being based on a wallet balance of a sender and a wallet balance of a receiver;
summing the wallet balance of the sender, the wallet balance of the receiver, a wallet balance of the computing device, a nonce, and an amount transferred from the perspective of the sender to generate a first input value;
summing the wallet balance of the sender, the wallet balance of the receiver, a wallet balance of the computing device, a nonce, and an amount transferred from the perspective of the receiver to generate a second input value;
validating that the first and second input values are equivalent;
calculating, responsive to the validating, a node output using the transaction parameters and the network parameters; and
outputting the node output.

30. The method of claim 29, further comprising normalizing the first and second input values using one or more logistic functions.

31. The method of claim 29, wherein the ad hoc network is an ad hoc neural network and the network parameters include a weight and a bias for the witness node.

32. The method of claim 29, wherein at least some of the transaction parameters and neural network parameters are homomorphically encrypted
